(19) United States
(12) Patent Application Publication
(10) Pub. No.: US 2019/0005061 A1
(43) Pub. Date: Jan. 3, 2019

(54) Distributive Control Assembly

(71) Applicant: Production Resource Group, LLC, New Windsor, NY (US)

(72) Inventor: Michael Wyatt, Dallas, TX (US)

(21) Appl. No.: 15/961,709

(22) Filed: Apr. 24, 2018

Related U.S. Application Data
(60) Provisional application No. 62/488,951, filed on Apr. 24, 2017.

(51) Int. Cl. G06F 17/30; H04L 29/06; G06F 21/62

(52) U.S. Cl. CPC G06F 17/30174; G06F 17/30371; G06F 2221/2141; G06F 21/6227; H04L 63/101

(57) ABSTRACT

An axis control system which uses a programmable logic controller connected to a plurality of workstations, where the workstations maintain a distributed control system.

This application claims priority from provisional application No. 62/488,951, filed Apr. 24, 2017, the entire contents of which are herewith incorporated by reference.

### BACKGROUND

Existing methods of motion control for the entertainment industry use token passing between peers to provide control of effects across a network. This form of control can be found in theaters, exhibit halls, arenas and opera houses among others. Extensive separate configuration for each workstation is required. Additionally, these systems typically utilize a central server to maintain a common database.

### SUMMARY

The present application describes a system and method that addresses these shortcomings. According to an embodiment, a distributed system is used where all computers on the system have access to a common database that is replicated on each of the computers, and where an access control system addresses which users can access the system.

### BRIEF DESCRIPTION OF THE DRAWINGS

FIG. 1 shows a block diagram of the system.

### DETAILED DESCRIPTION

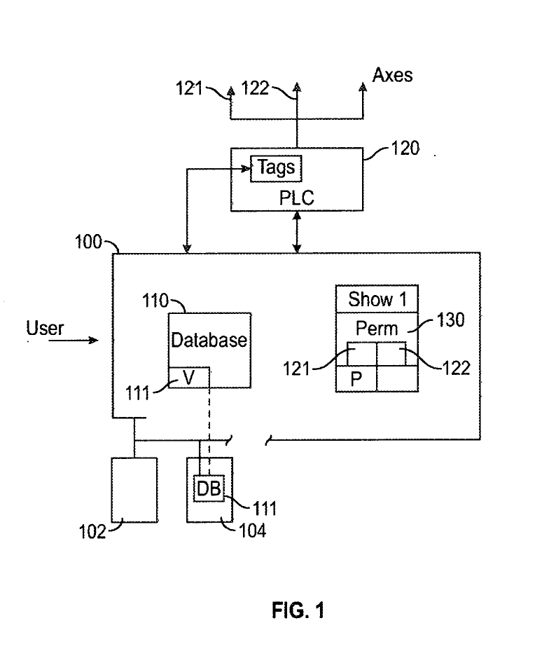

Embodiments describe a distributive control system. The distributive control includes a framework that combines motion control and database management within a special user interface that runs on a computer based system 100 as shown in FIG. 1, attached to a number of other systems shown as 102, 104, with it being understood that there could be many such systems. Each of these systems is referred to herein as a workstation, and the distributed control is a computer program that runs on each of these multiple different workstations, and synchronizes automatically to provide each workstation with identical configurations and database without user interaction.

Embodiments operate to provide each user with a choice in where motion control is programmed and executed. Unlike previous techniques, the sharing of control and maintenance of the database does not require a dedicated server, but rather uses distributive control that spans all hardware platforms. The motion control is described herein can be motion of objects on the stage, for example, and encompasses the ability to move these items on the stage while taking into account safety.

Framework Features
Multiple simultaneous workstations.
Changes to database are replicated automatically throughout all workstations in the network.
Each workstation maintains a full copy of the current database shown as 110, being replicated to the database 111 in workstation 104. This reduces the risk of single point database failure.
Local database 110 rebuilds automatically on failure.
Eliminates need for central server to maintain a common database.
Provides access to all axes from every workstation.
Hardware choices limited only by the targeted Safety Integrity Level requirements.
Eliminates the need for two or more PLC's in situations where multiple workstations are required.
Adding a workstation to the network requires no additional configuration other than IP address.
New workstations configure and replicate the database automatically when software is started.
System configuration is performed only once.

To provide these features two new functions are created.

A method to administer and arbitrate ownership of axes by the Programmable Logic Controller 120.

A method to administer and maintain an identical database at each workstation.

Ownership

Each workstation maintains a table of permissions shown as 130. A workstation that has control of an axis such as 121 is described as having “ownership” of that axis. There are 2 types of ownership: primary and secondary shown as P and S in the permission database 130. A workstation's ownership rights are configured within each “show”. A show configures which axes are available for control. The type of control for an axis is determined by the ownership rights of the workstation and password level of the user. There is no limit to the number of workstations that can be online at the same time with primary ownership rights but only one workstation at a time can own an axis. A workstation will have secondary rights of all axes of a show. Motion of an axis can only be initiated by the current owner. Ownership can be passed between workstations.

Primary Ownership Rights
Cue execution is permitted for that particular axis of that particular light or effect.
Jogging and Look based motion is permitted.
Cue creation and editing is permitted.
Programming a primary axis is possible regardless of current owner of that axis.
Axes can be locked to prevent transfer of ownership.

Secondary Ownership Rights
No cue selection or cue execution is permitted.
Jogging and Look based motion is permitted.
Only “named positions” can be created or edited. (A named position is a target value without a motion profile).
Axes cannot be locked.

Database

A database 110 is created which contains information describing each show, the available workstation IP address and all saved versions of each show. Each workstation maintains a complete copy of the database. Only certain workstations can modify the database, depending on ownership rights.

Database Behavior

Changes to the database are determined by the user's password level and the show's ownership rights.

All versions are kept for each show.

Saved changes create a new version of the show and are assigned a version number 111 in the database.

A change in the local version count triggers other workstations to replicate the missing version(s) to their local database.

Workstations replicate any missing versions from other workstations automatically.

When a workstation comes online all missing versions are replicated between all stations.

Requirements

Distributive control requires new software functions in both PLC and Control stations.
PLC functions:

To meet safety requirements this system employs the Programmable Logic Controller 120 to perform life safety functions related to motion control. “Ownership” in distributive control is maintained in the programmable logic controller. Tags are established, as areas of memory in the PLC that each workstation can read from and write to. Ladder logic within the PLC permits motion commands and transfer of ownership depending on the value of these tags. The PLC determines when it is safe and permissible to perform these actions. The inclusion of the ownership function within the PLC maintains a higher safety integrity level than a peer to peer token passing method.

Each axis has 4 tags defined in the PLC:

Axis Lock: The data type of this tag is bit. The value of this tag determines if an axis is available for transfer of ownership. This bit is set to 1 to prohibit and 0 to allow transfer of ownership.

Axis Motion: The data type of this tag is bit. The value of this tag represents the motion state of the axis. This bit is set by the PLC to 1 when the axis is executing motion and 0 when not executing motion. Transfer of ownership is prohibited when an axis's is executing motion.

Axis Owner ID: The data type of this tag is a 16 bit unsigned integer. The value of this tag represents the unique Owner ID number of the owner workstation.

Axis Heartbeat: The data type of this function is 16 bit signed integer. The value of this tag must change at a regular interval to maintain ownership. The owner workstation initially writes a value to this location. The PLC then increments the value by 1. A new value triggers a change event at the workstation which then increments the value again. The PLC compares this tags value at a fixed interval to the last known value. If no change is observed within the interval a counter representing retries is incremented. After a predetermined number of retries the PLC writes 0 to both the Owner ID tag and Axis Lock tag. As long as the retry limit is not reached, the PLC will continue to process commands from the workstation. If the heartbeat reaches a value greater than 32767, the PLC resets the value to 1.

Ladder logic within the PLC uses these tags to assign control and to determine when it is safe to accept commands from the workstations.
Workstation functions:

Routines within the workstation user interface software create ownership and database management functions

Ownership: A method to read and write data from a workstation to a programmable logic controller is added to the user interface software. This method constantly monitors the axis lock, axis motion, and axis heartbeat tags in the PLC. Decisions on when to request control are based upon the lock and motion tags. To assume ownership the workstation sends its unique owner ID value to the PLC. It also attempts to initialize the Axis Heartbeat tag. The PLC checks that the request is permissible before granting ownership. Ownership is granted when the PLC places the ID number in the Axis Owner ID tag and starts an interval timer. A change in heartbeat value triggers an event on the owner workstation which then increments the tag again.

Database management; A method to monitor database changes is added to the user interface software. This method calculates the total number of versions present in the local database for each show. These are read only integer values visible to other workstations on the network. Any change to version totals triggers an event at the other workstations. The event method copies the missing versions to the local database.

What is claimed is:

1. A system for controlling movable items which have movements along axes, comprising:
a computer that maintains a database that indicates, for a plurality of different objects to be moved, at least one axis through which those objects can be moved;
said computer running a routine that allows modification of said database, and automatically detects changes in the database of other computers, and synchronizes the changes in the database of the other computers to the database of the computer, where the other computers also synchronize changes in the database of the computer to the database of the other computers;
a central controller, which administers and arbitrates ownership of the at least one axis for the objects, by determining user capabilities of a user, and by determining for each user if they are authorized to have access to an axis, and if so allowing the user access to the axis.

2. The system as in claim 1, wherein the central controller is a programmable logic controller.

3. The system as in claim 1, wherein the central controller maintains tags for each of a plurality of axis indicating if the axis parameters can be moved from one computer to another computer.

4. The system as in claim 1, wherein the central controller maintains an axis owner ID which indicates an owner of the axis.

5. The system as in claim 1, wherein the central controller maintains a heartbeat for the axis, and where the owner workstation only maintains ownership of the axis when the heartbeat ID changes by a specified amount.
